(19) United States
(12) Patent Application Publication
(10) Pub. No.: US 2015/0212783 A1
(43) Pub. Date: Jul. 30, 2015

(54) METHOD OF CONTROLLING PERMISSION AND TOUCH LINK ELECTRONIC DEVICE UTILIZING THE SAME

(71) Applicant: MediaTek Singapore Pte. Ltd., Singapore (SG)

(72) Inventors: HEYAN CAO, Tianjin (CN); MI TANG, Beijing (CN); Tsung-Yueh CHIANG, Taichung City (TW)

(21) Appl. No.: 14/608,659

(22) Filed: Jan. 29, 2015

(30) Foreign Application Priority Data
Jan. 30, 2014 (CN) 201410044212.X

(51) Int. Cl. G06F 3/14; G09G 5/12; G06F 3/041

(52) U.S. Cl. CPC G06F 3/1423; G06F 3/0416; G09G 5/12; G09G 2370/16; G09G 2370/22

(57) ABSTRACT

A method of controlling permission and a touch link electronic device utilizing the same are described. The method of controlling permission, arranged for a first touch link electronic device, includes: establishing, by a touch panel of the first touch link electronic device, a communication channel to a second touch link electronic device; receiving a message from the second touch link electronic device via the communication channel; and determining permission of the second touch link electronic device according to the message, wherein the permission indicates operation permission of the second touch link electronic device on the first touch link electronic device.

### CROSS REFERENCE TO RELATED APPLICATIONS

This application claims priority of China Patent Application No. 201410044212.X, filed on Jan. 30, 2014, the contents of which are incorporated by reference herein.

### BACKGROUND OF THE INVENTION

1. Field of the Invention

The present invention relates to permission control, and in particular to a method of controlling permission and a touch link electronic device utilizing the same.

2. Description of the Related Art

Near Field Communication (NFC) is a contactless technology for identification and interconnection. Near Field Communication allows users to exchange the information, access contact and services by using the near electric field magnetic communication (such as the near electric field magnetic communication of 13.56 MHz) between the mobile devices, consumer electronics, PCs or smart electronic devices.

Due to the maturity of the market, the mobile phone with NFC can either support the function of the mobile payment or serve as a point of sale (POS). However, the proximity card reader or other similar elements must be added to the handheld device due to the NFC is operated by sending and receiving magnetic field signalssignal, which will make the size of the handheld device becomes larger, and the layout and the elements of the handheld device might be limited.

A touch link technology of the touch panel device which uses the existing panel and driver IC for communication has been developed recently, and has been described in US 2011/0304583, US 2013/0147760, CN 102916729A. The touch panel device includes a touch sensor. At least a part of the touch sensor includes at least a part of touch panel of the touch panel device. The touch panel can be the touch panel without a display function, such as the touch pad, or with the display function, such as the touch screen. The touch sensor includes the driving electrodes and the sensing electrodes set on the board for forming the capacitor structure. At least one of the driving electrodes and the sensing electrodes is used as the sending electrode, and at least one of the driving electrodes and the sensing electrodes is used as the receiving electrode. Thus, the signal can be sent and received by the existing electrodes and driver IC of the touch panel device so as to achieve the touch link according to the electric field without additional proximity card reader or other similar elements, thus reducing the size and the cost of the touch panel device.

FIG. 1 is a schematic diagram of touch transmissions between a first touch panel device 101 and a second touch panel 102 device according to the related art. As shown in FIG. 1, there are near electric fields 103a and 103b between the first touch panel device 101 and the second touch panel device 102. It should be noted that each of the first touch panel device 101 and the second touch panel device 102 can have the functionalities of transmitting and receiving signals. when the first touch panel device 101 transmits signals toward the second touch panel device 102, the communications medium used by the first touch panel device 101 is the electric field portion whose electric field direction is pointing toward the second touch panel device 102 (the near electric field 103a as shown in FIG. 1). In addition, when the second touch panel device 102 transmits signals toward the first touch panel device 101, the communications medium used by the second touch panel device 102 is the electric field portion whose electric field direction is pointing toward the first touch panel device 101 (the near electric field 103ba as shown in FIG. 1). The X channel and the Y channel shown in FIG. 1 may represent the sending electrodes and the receiving electrodes set on the board for forming the capacitor structure.

FIG. 2 is a logical block diagram of a touch communications system for achieving the touch link system between the first touch panel device 101 and the second touch panel device 102 in accordance with the prior art. The first touch panel device includes a message transmission system 201 shown in FIG. 2, and the second touch panel device includes a message reception system 202 shown in FIG. 2. The message transmission system 201 includes a touch link request signal generating unit 211, a communication connection establishing unit 212 and a first communication unit 213. The touch link request signal generating unit 211 may be arranged to generate a touch link request signal for sending touch link to the second touch panel 102 through the sending electrode. The communication connection establishing unit 212 establishes a communication connection with the second touch panel device 102 after the receiving electrodes receives a response signal from the second touch panel device 102. The first communication unit 213 sends the communication information or the data to the second touch panel device 102 through the sending electrodes after the communication connection is established.

The message reception system 202 includes a touch link request acknowledging unit 221, a communication connection establishing unit 222 and a second communication unit 223. The touch link request acknowledging unit 221 responds an acknowledge signal to the first touch panel device 101 through the sending electrodes after the receiving electrodes receive a touch link request signal sent from the first touch panel device 101. The communication connection establishing unit 222 establishes the communication connection with the first touch panel device 101 after the touch link request touch link request acknowledging unit 221 responses the acknowledge signal to the first touch panel device 101. The second communication unit 223 receives the communication information or the data sent from the first touch panel device 101 through the receiving electrodes after the communication connection is established.

FIG. 3 illustrates a first touch panel 301 of the first touch panel device 101 shown in FIG. 1 and a second touch panel 302 of the second touch panel device 102 shown in FIG. 1 according to the related art. As shown in FIG. 3, each touch panel of the first touch panel 301 and the second touch panel 302 may comprise a touch sensor (not completely shown in FIG. 3). For example, the touch sensor of the first touch panel 301 may comprise a set of transmitting electrodes installed on at least one substrate of the first touch panel 301 (e.g. the transmitting electrode 311) for transmitting signals, and may comprise a set of receiving electrodes installed on at least one substrate of the first touch panel 301 (e.g. the receiving electrode 312) for receiving signals. In another example, the touch sensor of the second touch panel 302 may comprise a set of transmitting electrodes installed on at least one substrate of the second touch panel 302 (e.g. the transmitting electrode 321) for transmitting signals, and may comprise a set of receiving electrodes installed on at least one substrate of the second touch panel 302 (e.g. the receiving electrode 322) for receiving signals.

FIG. 4 is a flow chart of the touch link method in accordance with the prior art. First, in step S401, the touch link request signal generating unit 211 generates a touch link request signal, and sends to the second touch panel device 102 through the sending electrodes. Then the receiving electrodes receive the acknowledge signal responded from the second touch panel device 102 (step S402). After that, the communication connection establishing unit 212 establishes the communication connection with the second touch panel device 102 (step S403). Finally, the method goes to the step S404, the first communication unit 213 sends the communication information or the data to the second touch panel device 102 through the sending electrodes. the first touch panel 301 and the second touch panel 302 further include a touch sensor (not fully shown in FIG. 3). The touch sensor includes the sending electrodes 311, 321 and the receiving electrodes 312, 322 disposed on the board for forming the capacitor structure. The sending electrodes 311, 321 are arranged to send the signal, and the receiving electrodes 312, 322 are arranged to receive the signal.

After touch connection is established, the touch link electronic device requires a control mechanism to set various access and control permissions based on different property configurations to ensure data security.

### BRIEF SUMMARY OF THE INVENTION

A detailed description is given in the following embodiments with reference to the accompanying drawings.

An embodiment of a method is described, the method controlling permission, adopted by a first touch link electronic device, and comprising: establishing, by a touch panel of the first touch link electronic device, a communication channel to a second touch link electronic device; receiving a message from the second touch link electronic device via the communication channel; and determining permission of the second touch link electronic device based on the message, wherein the permission indicates operation permission of the second touch link electronic device on the first touch link electronic device.

Another embodiment of a touch link electronic device is disclosed, comprising a touch panel, a touch link module and a control module. The touch link module is configured to establish a communication channel to a second touch link electronic device, and receive a message from the second touch link electronic device via the communication channel. The control module is configured to determine permission of the second touch link electronic device based on the message, wherein the permission indicates operation permission of the second touch link electronic device on the first touch link electronic device.

An embodiment of a method is described, the method controlling permission, adopted by a touch link electronic device, and comprising: establishing, by a touch panel of the touch link electronic device, a communication channel to a first touch link electronic device; and transmitting a message to the first touch link electronic device via the communication channel.

An embodiment of a touch link electronic device is provided, comprising a touch panel and a touch link module. The touch link module is configured to establish a communication channel to a first touch link electronic device via the touch panel, and transmit a message to the first touch link electronic device via the communication channel.

### BRIEF DESCRIPTION OF THE DRAWINGS

The present invention can be more fully understood by reading the subsequent detailed description and examples with references made to the accompanying drawings, wherein:

FIG. 1 is a schematic diagram of touch transmissions between a first touch panel device and a second touch panel device according to the related art;

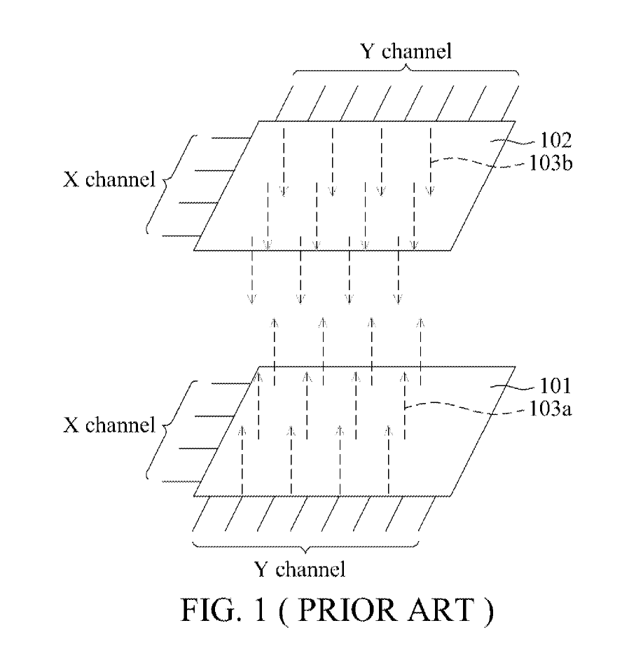

FIG. 2 is a logical block diagram of a touch communications system for achieving the touch link system between the first touch panel device and the second touch panel device in accordance with the prior art;

FIG. 3 illustrates a first touch panel of the first touch panel device shown in FIG. 1 and a second touch panel of the second touch panel device shown in FIG. 1 according to the related art;

FIG. 4 is a flow chart of the touch link method in accordance with the prior art;

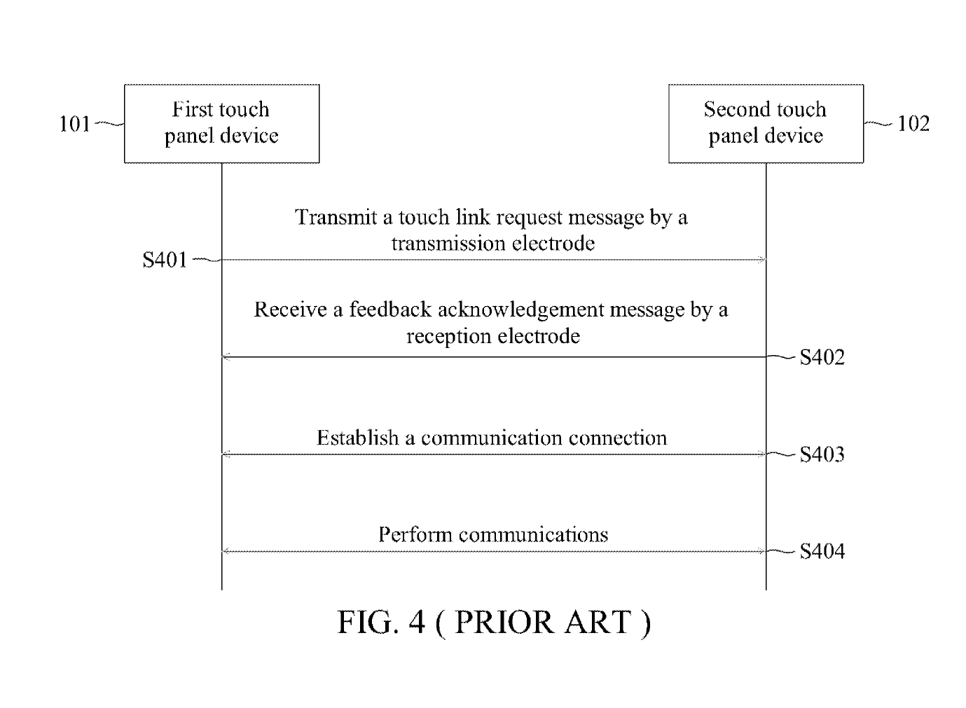

FIG. 5 is a block diagram of a touch link communication system according to an embodiment of the invention;

FIG. 6 is a flowchart of a permission control method according to an embodiment of the invention;

FIG. 7 is a flowchart of a permission control method according to an embodiment of the invention; and

FIG. 8 is a flowchart of a permission control method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

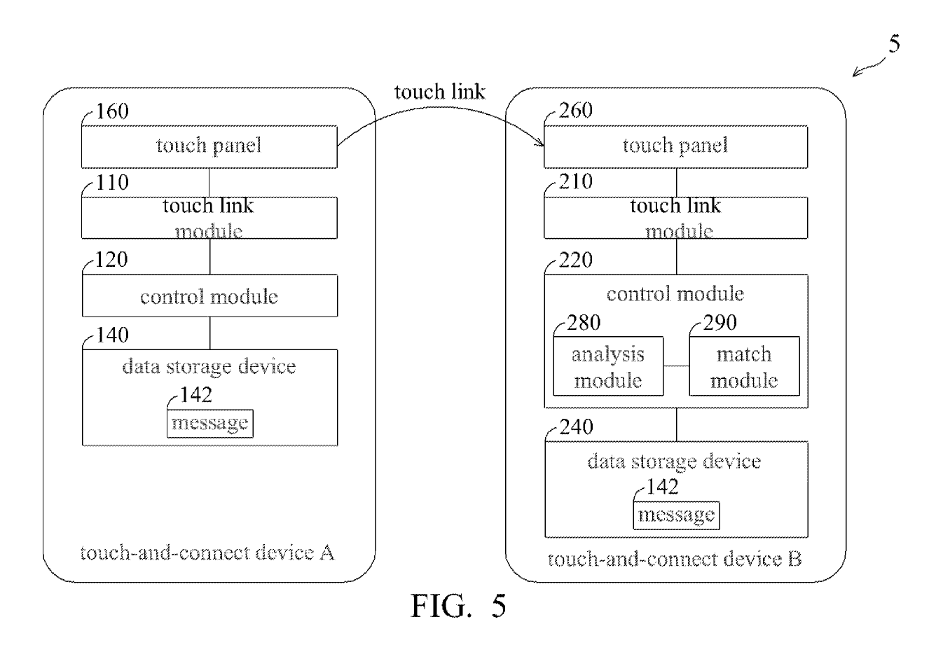

FIG. 5 is a block diagram of a touch link communication system 5 according to an embodiment of the present invention, including touch link electronic devices A and B which can establish a touch link therebetween. The touch link electronic devices A and B may be a Personal Digital Assistant (PDA), smart watch, smartphone, notebook, tablet, television, printer, smart home appliance, electronic reader, calculator, ticket vending machine, digital photo kiosk, digital map, or any electronic device equipped with a touch link module (such as a touch integrated circuit). When the distance between the touch link electronic devices A and B is in the scale of millimeters (e.g. 5 millimeters), the two touch link electronic devices can be regarded as physically nearby, and a touch link may be created between the touch link electronic devices A and B. It is necessary to determine an access or control permission of the touch link electronic devices A to the touch link electronic device B in advance if the touch link electronic devices A wishes to perform an access control to the touch link electronic device B, e.g., the touch link electronic device A wishes to use a certain function of the touch link electronic device B. The touch link electronic devices A and B in the touch link communication system 5 may determine the access or control permission.

In particular, in the touch link communication system 5, the touch link electronic device A includes a touch link module 110, a control module 120, a touch panel 160 and a data storage device 140. The data storage device 140 can store a message 142, and may be, for example a subscriber identifier module (SIM) card, flash memory, and others. The touch link electronic device B includes a touch link module 210, control module 220, touch panel 260, data storage device 240 and database 250 (not shown). The control module 220 contains an analysis module 280 and matching module 290. The database 250 may be stored in the data storage device 240. The control modules 120 and 220, including a digital signal processing (DSP), microcontroller (MCU), central-processing unit (CPU) or a plurality of parallel processing units associated with a parallel processing environment, are configured to operate the operating system and applications.

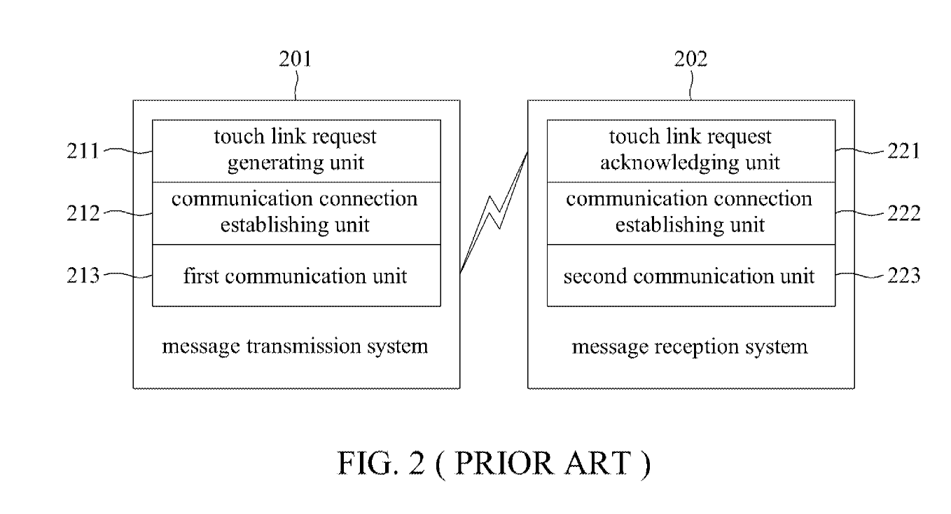

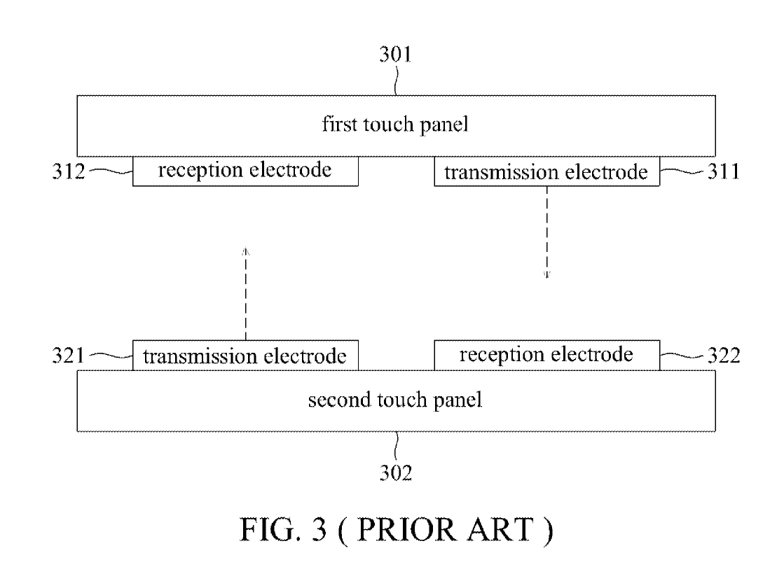

In one embodiment, the touch link module 110 includes a sensing module 130 and connection module 132 (not shown), and similarly, the touch link module 210 includes a sensing module 230 and connection module 232 (not shown), wherein the sensing modules 130 and 230 have identical structure and functions, and the connection modules 132 and 232 have identical structure and functions. Each of the touch link electronic devices A and B can determine whether a device is physically nearby (such as in close proximity or touching) by the sensing modules 130 or 230. For example, the sensing module 230 detects whether a device is physically adjacent from the touch link electronic device A. Upon detecting that a device is physically adjacent, a first communication channel is established by the connection module 132. For instance, the sensing module 130 senses the electromagnetic field interacting between the touch link electronic devices A and B (e.g., determining the presence of the interacting electromagnetic field through a sending electrode and receiving electrode of the touch panel, as indicated in FIG. 3), and determines whether the touch link electronic device B is physically nearby according to a variation in the electromagnetic field. Once a nearby device is detected, the connection module 132 and 232 will establish the first communication channel. In one embodiment, the connection module 132 may be the message transmission system as shown in FIG. 2, the connection module 232 may be the message reception system as shown in FIG. 2, the first communication unit 213 of the touch panel 160 of the touch link electronic device A and the second communication unit 223 of the touch panel 160 of the touch link electronic device B in FIG. 2 are utilized to establish the first communication channel.

In one embodiment of the invention, the touch link electronic device A detects that the touch link electronic device B is physically nearby, the connection module 132 of the touch link module 110 and the connection module 232 of the touch link electronic device B establish the first communication channel therebetween, the touch link electronic device A sends the message 142 to the touch link electronic device B via the first communication channel. In one embodiment, the message is a property message 142 of the touch link electronic device A. Specifically, the property message may be a message indicating identifier property such as an International Mobile Equipment Identity number (IMEI), International Mobile Subscriber Identity (IMSI), Mobile Station ISDN (MSISDN), device name, email, or contact information.

After receiving the property message 142, the touch link module 210 can save it in the data storage device 240 in the touch link electronic device B. The data storage device 240 may be a SIM card or flash memory. The analysis module 280 analyzes the property message 142 to obtain the property value of the touch link electronic device A. The matching module 290 matches the property message of the touch link electronic device A to the property messages in the database 250 to find a predefined property message matching the property message of the touch link electronic device A. Since they are in the database 250 of the touch link electronic device B, each predefined property message corresponds to a specific permission, thus the permission of touch link electronic device A, which indicates the operation permission of the touch link electronic device A to operate on the touch link electronic device B, can be determined. The operation permission includes access permission and/or control permission. In one example, when the property message is a name, contact, or email, the matching module 290 can search the access or control permission from a phonebook (i.e., the database 250) for a matched name, contact, or email, to determine the access or control permission of the touch link electronic device A. For example, when the property message of the touch link electronic device A is not in the phonebook of the touch link electronic device B, the matching module 290 can further identify the touch link electronic device A as a “Stranger”, since “Stranger” corresponds to the most limited permission (e.g., no access or control operation is allowed), the control module 220 of the touch link electronic device B does not allow the touch link electronic device A to perform any operation. In another example, when the property message of the touch link electronic device A matches a “Usual Contact” list in the phonebook of the touch link electronic device B, since the “Usual Contact” corresponds to limited permission, the control module 220 can permit limited function, such as making a call or sending a short message, and so on, to the touch link electronic device A. In yet another example, when the property message of the touch link electronic device A matches a “Friends” list in the phonebook of the touch link electronic device B, since the “Friends” corresponds to a higher permission, the control module 220 can permit more functions, such as making a call or sending a short message, and sharing the data in the touch link electronic device B, to the touch link electronic device A.

In some embodiments, after the matching module 290 of the touch link electronic device B determines the permission of the touch link electronic device A, the touch link electronic device B can transmit a response message to the touch link electronic device A via the first communication channel to indicate the function or a set of functions that are available to the touch link electronic device A. The touch link electronic device A receives the response message via the first communication channel, and selects or issues an instruction to the touch link electronic device B, where the instruction indicates at least one operation is to be performed. In other embodiments, the touch link electronic device B does not respond with the function or any set of functions that are available to the touch link electronic device A. In this situation, after the touch link electronic device A sends an instruction for executing a function to the touch link electronic device B, the touch link electronic device B can determine whether it will follow the instructions sent from the touch link electronic device A according to the control permission of the touch link electronic device A, where the instruction indicates at least one operation is to be performed. When the operation matches the permission, this situation indicates that performing the operation is allowed, and the touch link electronic device will perform the instruction.

Although the embodiment in FIG. 5 only illustrates the touch link electronic device A sending the property message to the touch link electronic device B via the first communication channel, and the touch link electronic device B determines the control permission of the touch link electronic device A. In another variation of the embodiment, the control module 120 of the touch link electronic device A may further include an analysis module and matching module. Those skilled in the art would recognize that the touch link communication system 5 also supports the touch link electronic device B transmitting the property message to the touch link electronic device A via the first communication channel. In response, the touch link electronic device A accepts the property message from the touch link electronic device A and determines the permission of the touch link electronic device B. In this manner, after the touch link electronic devices A and B touch each other and establish the first communication channel they can exchange the property messages and determine the control permission of sharing functions with each other.

Although the touch link communication system 5 includes the touch link electronic devices A and B, but it is not limited to two touch link electronic devices. In practice, the touch link communication system may include more than two touch link electronic devices. In a variation of the embodiment, the touch link communication system 5 may further include a touch link electronic device C, where the touch link electronic device C has a structure that is identical to that of the touch link electronic device A. People skilled in the art can recognize that the touch link communication system 5 also supports the touch link electronic device C sending a property message to the touch link electronic device B, and in response, the touch link electronic device B can determine the control permission of the touch link electronic device C by matching the property message to its database. That is, the touch link electronic device B may establish touch connections with multiple touch link electronic devices, receive messages, and set the access and control permission for the multiple touch link electronic devices.

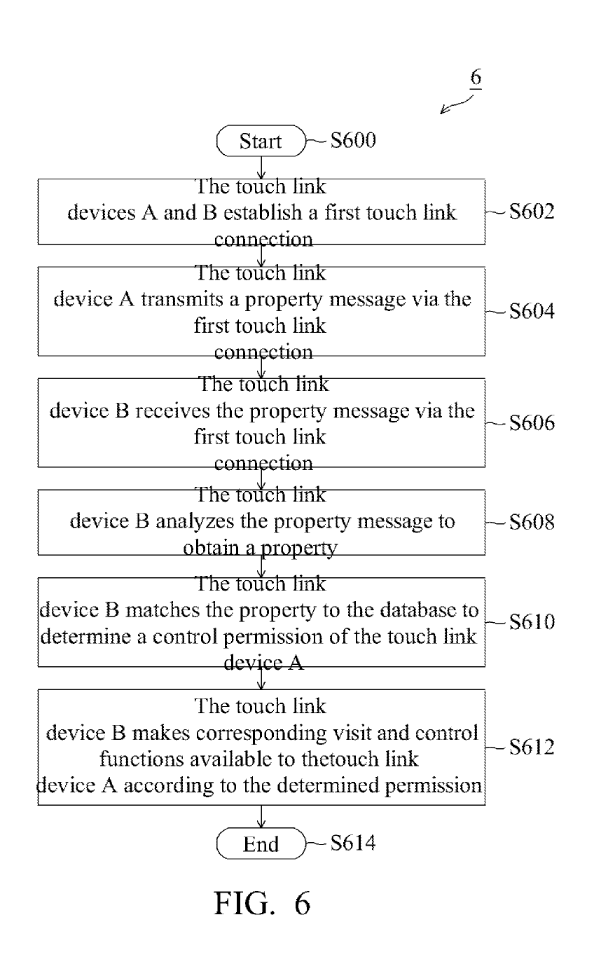

FIG. 6 is a flowchart of a permission control method 6 according to an embodiment of the invention, adopted by the touch link communication system 5 in FIG. 5.

The permission control method 6 is initialized when the touch link electronic devices A and B are in touch in close proximity (S600). Firstly, the first communication channel between the touch link electronic devices A and B is established (S602). Upon establishing the first communication channel, the touch link electronic device A can send the property message to the touch link electronic device B (S604). The property message may be an IMEI, IMSI, MSISDN, device name, email, contact information, or information which identifies the device. Because the distance between the touch link electronic devices A and B is short, almost equaling the touch distance, the security of the property message transmitted via the first communication channel is ensured.

Correspondingly, the touch link electronic device B receives the property message from the touch link electronic device A via the first communication channel (S606). After receiving the property message, the touch link electronic device B analyzes the property message to obtain the property information of the touch link electronic device A (S608), and subsequently, the touch link electronic device B searches for a property message in the database 250, which matches the property massage, thereby determining the control permission of the touch link electronic device A (S610). The database may contain a lookup table, database, or file including an IMEI, IMSI, MSISDN, device name, email, contact information, and matched property. The touch link electronic device B may configure the control permission corresponding to the property message in the database 250 in advance.

Next, the touch link electronic device B makes the access and control functions available to the touch link electronic device A, where the access and control functions correspond to the determined permission of the touch link electronic device A (S612). The permission control method 6 is then completed and exited (S614). In one embodiment, when the touch link electronic device B is a smartphone, the corresponding access control functions may be making a phone call or sending a short message. When the touch link electronic device B is a television, the corresponding access control functions may be changing the volume or channel.

The permission control method 6 controls the touch link electronic device A to transmit the property message to the touch link electronic device B, so that the touch link electronic device B can match the property message to the database and determine the control permission of the touch link electronic device A.

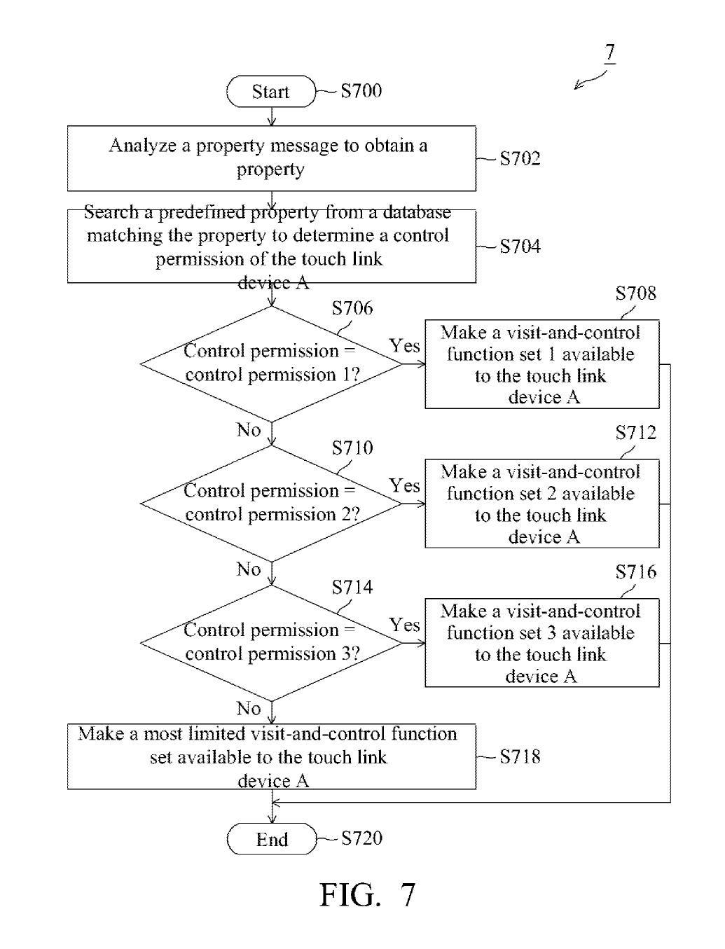

FIG. 7 is a flowchart of a permission control method 7 according to an embodiment of the invention, adopted by the touch link electronic device B for determining the control permission of the touch link electronic device A, where the control permission represents the available function or a set of functions of the touch link electronic device B to the touch link electronic device A.

The permission control method 7 is initiated after the touch link electronic device B receives the property message from the touch link electronic device A (S700). Firstly, the analysis module of the touch link electronic device B can analyze the property message to obtain the property information (S702), and then the matching module 290 of the touch link electronic device B can search for the predefined property messages in the database 250 which matches the property message to determine the control permission of the touch link electronic device A (S704). For instance, the touch link electronic device B may configure the predefined property values configured as control permissions 1, 2, and 3.

The touch link electronic device B can determine the function that is available to the touch link electronic device A according to the determined control permission. The touch link electronic device B can determine the class of determined control permission, and make the corresponding functions available to the touch link electronic device A according to the class of determined control permission. Initially, the touch link electronic device B can determine whether the control permission belongs to the control permission class 1 (S706). If so, making a set of access and control functions 1 available to the touch link electronic device A (S708), i.e., the touch link electronic device A may issue an instruction to use any function in the set of access and control functions 1, and subsequently, the touch link electronic device B may accept the instruction to perform the function in the set of access and control functions 1.

If the touch link electronic device B determines that the control permission does not belong to the control permission class 1, then it can continue determining whether the control permission belongs to the control permission class 2 (S710). If so, making a set of access and control functions 2 available to the touch link electronic device A (S712), i.e., the touch link electronic device A may issue an instruction to use any function in the set of access and control functions 2, and subsequently, the touch link electronic device B may accept the instruction to perform the function in the set of access and control functions 2.

If the touch link electronic device B determines that the control permission does not belong to the control permission class 2, then it can continue determining whether the control permission belong to the control permission class 3 (S714). If so, making a set of access and control functions 3 available to the touch link electronic device A (S716), i.e., the touch link electronic device A may issue an instruction to use any function in the set of access and control functions 3, and subsequently, the touch link electronic device B may accept the instruction to perform the function in the set of access and control functions 3.

If the touch link electronic device B determines that the control permission does not belong to the control permission class 3, since the touch link electronic device B does not configure the other class, it can only make a set of the most limited access and control functions available to the touch link electronic device A (S718). For example, the set with the most limited access and control functions may be for the touch link electronic device A to be forbidden from using any function on the touch link electronic device B.

The permission control method 7 is then completed (S720). People skilled in the art may recognize that the touch link electronic device B can determine more classes of determined control permission, such as five classes, and make the corresponding functions available to the touch link electronic device A according to the five classes of determined control permission, respectively.

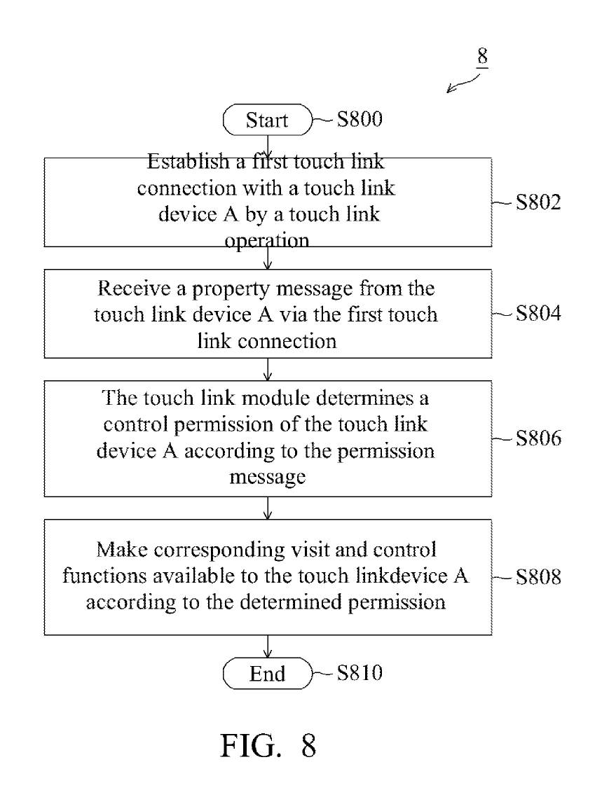

FIG. 8 is a flowchart of a permission control method 8 according to another embodiment of the invention, adopted by the touch link electronic device B, determining the control permission of the touch link electronic device A, where the control permission represents the available function or a set of functions of the touch link electronic device B to the touch link electronic device A.

The permission control method 8 is initiated after the touch link electronic devices A and B are in touch in close proximity (S800). Firstly, the touch link electronic devices A and B adopt the touch link process to establish the first communication channel (S802). Next, the touch link electronic device B can receive the property message from the touch link electronic device A via the first communication channel (S804).

The matching module 290 of the touch link electronic device B can determine the control permission of the touch link electronic device A according to the property message (S806). In particular, the touch link electronic device B stores the user configured database 250, the matching module 290 can search for an item in the database 250 matched to the property message. If there is an item matched to the property message in the database 250, then a corresponding permission class will be set based on the matched item, and consequently, the control permission of the touch link electronic device A will be determined according to the corresponding permission class. If the matching module 290 finds no item in the database 250 matched to the property message, then the most limited control permission will be assigned to the touch link electronic device A.

After the control permission is determined, the touch link electronic device B can make the corresponding set of access and control functions available to the touch link electronic device A according to the determined control permission (S808).

As used herein, the term “determining” encompasses calculating, computing, processing, deriving, investigating, looking up (e.g., looking up in a table, a database or another data structure), ascertaining and the like. Also, “determining” may include resolving, selecting, choosing, establishing and so on.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or another programmable logic device, discrete gate or transistor logic, discrete hardware components or any combination thereof designed to perform the functions described herein. A general purpose processor may be a microprocessor, but in the alternative, the processor may be any commercially available processor, controller, micro controller or state machine.

The operations and functions of the various logical blocks, modules, and circuits described herein may be implemented in circuit hardware or embedded software codes that can be accessed and executed by a processor.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of controlling permission, arranged for a first touch link electronic device, the method comprising:
establishing, by a touch panel of the first touch link electronic device, a communication channel to a second touch link electronic device;
receiving a message from the second touch link electronic device via the communication channel; and
determining permission of the second touch link electronic device according to the message, wherein the permission indicates operation permission of the second touch link electronic device on the first touch link electronic device.

2. The method of claim 1, further comprising:
when detecting that a distance between the first and second touch link electronic devices is less than or equal to 5 millimeters, establishing the communication channel.

3. The method of claim 1, wherein the message is a property message of the second touch link electronic device.

4. The method of claim 3, wherein the step of determining the permission comprises:
determining, by a control module, the permission of the second touch link electronic device according to the property message.

5. The method of claim 1, wherein the step of determining the permission comprises:
matching, by a control module, the message to data in a database of the first touch link electronic device to determine the permission of the second touch link electronic device.

6. The method of claim 5, wherein the step of determining the permission comprises:
when no match to the message is found in the database, determining a most limited permission as the permission of the second touch link electronic device.

7. The method of claim 3, further comprising:
analyzing, by an analysis module of the first touch link electronic device, the property message to obtain property information of the second touch link electronic device;
wherein the control module determines the permission of the second touch link electronic device according to the property information.

8. The method of claim 1, further comprising:
providing, by a control module, the operation permission to the second touch link electronic device.

9. The method of claim 1, further comprising:
responding a response message to the second touch link electronic device via the communication channel, wherein the response message contains the permission.

10. The method of claim 1, further comprising:
receiving an instruction from the second touch link electronic device via the communication channel, wherein the instruction instructs at least one operation;
determining whether the instruction should be performed based on the permission; and
performing the instruction when the at least one operation complies with the permission.

11. A touch link electronic device, comprising:
a touch panel;
a touch link module, configured to establish a communication channel to a second touch link electronic device, and receive a message from the second touch link electronic device via the communication channel; and
a control module, configured to determine permission of the second touch link electronic device according to the message, wherein the permission indicates operation permission of the second touch link electronic device on the first touch link electronic device.

12. The touch link electronic device of claim 11, wherein the touch link module includes:
a sensing module, configured to determine whether the touch link electronic device is in close proximity to the second touch link electronic device; and
a connection module, configured to establish the communication channel via the touch link module when the sensing module determines that the touch link electronic device and the second touch link electronic device are in close proximity.

13. The touch link electronic device of claim 12, wherein when a distance between the first and the second touch link electronic devices is less than or equal to 5 millimeters, the sensing module is configured to determine that the touch link electronic device is in close proximity to the second touch link electronic device.

14. The touch link electronic device of claim 11, wherein the message is a property message of the second touch link electronic device.

15. The touch link electronic device of claim 14, wherein the control module is configured to determine the permission of the second touch link electronic device according to the property message.

16. The touch link electronic device of claim 11, further comprising a database; wherein the control module is configured to match the message to data in the database to determine the permission of the second touch link electronic device.

17. The touch link electronic device of claim 16, wherein when no match to the message is found in the database, the control module is configured to determine a most limited permission as the permission of the second touch link electronic device.

18. The touch link electronic device of claim 14, wherein the control module further comprises an analysis module, configured to analyze the property message to obtain a property information of the second touch link electronic device; and
the control module is configured to determine the permission of the second touch link electronic device according to the property.

19. The touch link electronic device of claim 11, wherein the control module is configured to make the operation permission available to the second touch link electronic device.

20. The touch link electronic device of claim 11, wherein the touch link electronic device is configured to respond a response message to the second touch link electronic device via the communication channel, and the response message contains the permission.

21. The touch link electronic device of claim 11, wherein:
the touch link electronic device is configured to receive an instruction from the second touch link electronic device via the communication channel, and the instruction instructs at least one operation; and
the control module is configured to determine whether the instruction should be performed based on the permission; and
when the at least one operation complies with the permission, the touch link electronic device is configured to perform the instruction.

22. A method, controlling permission, adopted by a touch link electronic device, the method comprising:
establishing, via a touch panel of the touch link electronic device, a communication channel to a first touch link electronic device; and
transmitting a message to the first touch link electronic device via the communication channel.

23. The method of claim 22, further comprising:
when detecting that a distance between the touch link electronic device and the first touch link electronic device is less than or equal to 5 millimeters, establishing the communication channel.

24. The method of claim 22, wherein the message is a property message of the touch link electronic device.

25. The method of claim 22, further comprising:
receiving a response message from the first touch link electronic device via the communication channel;
wherein the response message indicates permission, and the permission indicates operation permission of the first touch link electronic device on the touch link electronic device.

26. The method of claim 22, further comprising:
transmitting an instruction to the first touch link electronic device via the communication channel;
wherein the instruction instructs at least one operation.

27. A touch link electronic device, comprising:
a touch panel; and
a touch link module, configured to establish a communication channel to a first touch link electronic device via the touch panel, and transmit a message to the first touch link electronic device via the communication channel.

28. The touch link electronic device of claim 27, wherein the touch link module further comprises:
a sensing module, configured to determine whether the touch link electronic device and the first touch link electronic device are physically adjacent;
a connection module, configured to establish the communication channel via the touch link modulel when the sensing module determines that the touch link electronic device and the firsttouch link electronic device are physically adjacent.

29. The touch link electronic device of claim 28, wherein when detecting a distance between the touch link electronic device and the first touch link electronic device is less than or equal to 5 millimeters, the sensing module is configured to determine that the touch link electronic device and the first touch link electronic device are physically adjacent.

30. The touch link electronic device of claim 27, wherein the message is a property message of the touch link electronic device.

31. The touch link electronic device of claim 27, wherein the touch link electronic device is configured to receive a response message from the first touch link electronic device via the communication channel;
the response message indicates permission; and
the permission indicates operation permission of the first touch link electronic device on the touch link electronic device.

32. The touch link electronic device of claim 27, wherein the touch link electronic device is configured to transmit an instruction to the first touch link electronic device via the communication channel; and
the instruction instructs at least one operation.
